(19) United States
(12) Patent Application Publication
(10) Pub. No.: US 2004/0058124 A1
(43) Pub. Date: Mar. 25, 2004

(54) Membrane covered structural panel for deck construction and a method of constructing exterior decks

(76) Inventor: Douglas D. Raaum, Annapolis, MD (US)

Correspondence Address: Walter A. Reiter, III, Esq., 170 West Street, Annapolis, MD, 21401, US

(21) Appl. No.: 10/247,105

(22) Filed: Sep. 19, 2002

(51) Int. Cl. B32B 3/04

(52) U.S. Cl. 428/122

(57) ABSTRACT

The present invention is a combination of a structural panel comprised of an upper skin, a core material, a lower skin, and an impervious membrane bonded to the upper skin and a method of constructing exterior decks using said structural panel or multiple structural panels joined by joists of dimension lumber positioned in said channels and joined together.

### FIELD OF THE INVENTION

The present invention relates to combination of a foam cored plywood or composite panel adhesively bonded to an impervious membrane and a method of constructing exterior decks using the combination.

### BACKGROUND OF THE INVENTION

The present invention is a superior product for the construction of exterior decks and a superior method for the construction of such decks.

Presently, exterior decks for residential and commercial structures are commonly constructed of dimension, pressure treated lumber. Pressure treated lumber is necessary to raise the rot resistance of the lumber. The lumber is treated with the poison cyanide. There are significant health concerns associated with exposure to cyanide.

The method of constructing an exterior deck of dimension lumber requires the builders to cut and fasten numerous individual pieces to create the entire structure. This method is labor intensive and requires a high degree of skill to obtain a workmanlike end product.

The present invention is a rot resistant, membrane covered structural panel that is a superior product for the construction of exterior decks. The present invention is also a method of constructing an exterior deck using the structural panels that is simpler and less labor intensive than the methods presently used.

The membrane covered structural panel is a combination of two previously known building materials to create a new and unique product that is synergistically superior to the individual products and superior to the existing technology commonly used to construct exterior residential decks. The two materials are a foam cored plywood faced structural panel and an impervious continuous membrane.

By using this combination in the construction of an exterior deck, the builder is able to simplify construction and minimize the support structure as compared to the common “stick built” deck comprised of pressure treated dimension lumber.

The traditional material used to construct exterior decks is dimension lumber treated with, among other ingredients, an arsenic salt to improve rot resistance. The stick built deck by its nature is comprised of a much greater number of component pieces. To properly construct such a deck, the individual component pieces must be cut, shaped and fastened by somewhat skilled labor to obtain a workmanlike product.

The membrane covered structural panel constructed deck, however, is comprised of a smaller number of component pieces and because of its inherent stability and strength, superior to dimension lumber, requires far fewer support members further simplifying construction and installation.

However, the structural panels presently known in the industry, without the impervious membrane covering are not suitable for use to construct exterior decking. The structural panels are not sufficiently weather resistant to provide a suitably durable exterior deck.

The membrane covered structural panel constructed deck solves this problem by the addition of a bonded, moisture impervious and continuous membrane. The application of the membrane makes the panel a suitable deck component that will be sufficiently weather resistant to provide a serviceable deck structure.

The present state of the art in exterior deck construction is, as described, stick built dimension treated lumber. Due to pending environmental regulations, pressure treated low-grade lumber will no longer be available. Without the present invention, builders and homeowners would be faced with the prohibitive cost of obtaining naturally weather resistant lumber from dwindling natural stock or resorting to a wood substitute. Therefore, the membrane covered structural panel constructed deck will serve a great need.

The method of the present invention is comprised of forming a channel along the edge of the panel by removing the foam core to a depth sufficient to accommodate appropriate dimension lumber on edge. Fasteners are then driven through the plywood faces of the panel, into the edge of the dimension lumber. Another similarly sized piece of dimension lumber is attached, sister fashion, to the joist already inserted into the panel forming a doubled joist and a tongue. The preformed groove of the adjacent panel is aligned to accommodate the tongue formed by sistering the joints and fasteners are driven through the edges of the adjacent panel into the so-formed tongue.

This dado joint, tongue and groove method is also used to attach the deck to the structure from which it is appendaged. The resulting deck is supported upon posts and beams, the beams running parallel to the building or house structure as is presently practiced but at greater spans due to the structural superiority of this method as compared to decks stick built of dimension lumber.

It is therefore an object of this invention to provide a useful construction material suitable for constructing exterior decks and a further object of this invention to provide a useful method of constructing exterior decks.

U.S. Pat. Nos. 6,363,674 and 6,085,479 by Carver disclose and claim a premanufactured structural building panel and method of constructing a building using these panels as wall and roof members. The panels are described as having a “C” shaped channel along the outer edge of the panels to accommodate support members. The patents further claim and disclose wall members including a weatherable outer covering selected from the group consisting of weatherable plaster, and elastomeric skin, an acrylic layer and roof shingles.

U.S. Pat. No. 6,167,624 Synthetic Panel & Method by Lanahan, discloses and claims a polymeric foamed material and a brace receiving configured slot disposed in the foam for conjoining the panels.

U.S. Pat. No. 6,044,604 Composite roofing members having improved dimensional stability by Clayton discloses and claims a foam core composite recovery board with various acing materials so configured to accommodate the application of a weather protective and continuous membrane.

U.S. Pat. No. 5,799,462 Method and apparatus for lightweight, insulated, structural building panel systems by McKinney, discloses and claims a method of manufacturing composite structural building panels for floors, walls and roofs with the components for securing adjacent panels to each other built into the interior of each panel and serving as a structural component and an optional interlocking component at the same time. A variety of interior and exterior surfaces can be applied directly over the panels. The resulting panels can span and reach greater distances and heights while holding drastically higher shear and diaphragm values as well as significantly higher structural live, dead, wind and snow loads. The panels comprise a “J” shaped structural channel configured to accept fastening to structural strut members.

U.S. Pat. No. 4,774,794 Energy efficient building system by Grieb discloses and claims a building constructed with self supporting foam-cement building blocks with a strong thin continuous structural and architectural coating on the surface of the blocks the coating being formed by a cement reinforced with fiberglass mesh and roving. The blocks interconnect with a key or spline system to form a monolithic structure.

U.S. Pat. No. 4,670,079 Method of forming a walking surface panel by Thompson discloses and claims a method of providing a preformed surface material for flooring, decking, walkways and roadways, more particularly for use with marine dock structures. The method includes applying a coating of a catalyzed resin material over one surface of a sheet of plywood substructure so as to seal the substructure as the resin hardens, and also coating one surface of a fiber-cement sheet with a catalyzed resin material and allowing it to harden. An alternative arrangement is also provided wherein the substructure is a thick plastic foam core encased in a fiberglass and polyester resin.

U.S. Pat. No. 4,063,395 Twin membrane, self sealing mechanically fastened insulated roof deck system by Stewart discloses and claims a roofing system comprising a fire resistant rigid class A fire rated board as a substrate having bonded thereto a sheet of foamed, insulating resin and having a tough weather resistant membrane bonded to the upper surface. A ledge of substrate about ½ inch wide protrudes beyond the formed sheet to enable the composite to be fastened to a steel roof or the like by mechanical fasteners. The channel formed by the abutting roofing panels is filled with insulating foam and covered with a membrane strip that is attached at its edges to the membrane surface of the roofing panel.

### SUMMARY OF THE INVENTION

The invention is a combination of a cored, structural panel, faced with a durable skin and an impervious membrane attached to the durable skin of the panel to form a surface suitable for the construction of exterior decks. The invention is also a method of constructing exterior decks using the membrane covered structural panel.

### BRIEF DESCRIPTION OF THE DRAWINGS

The foregoing and other objects, aspects, and advantages will be better understood from the following detailed description of preferred embodiments of the invention with reference to the drawings, in which:

FIG. 1 is a perspective diagram of the Membrane Covered Structural Panel assembled into an exterior deck. “A” represents the impervious membrane shown in cut-away view over “B” the structural panels.

FIG. 2 is a perspective view of the structural panels assembled into an exterior deck. “C” is the foam core of the structural panels. “D” is the dimension lumber support structure for the deck constructed with the method of the present invention. “E” is the plywood or composite board facing of the structural panels. “F” is a representation of the dimension lumber, dado joint method of joining the structural panels together.

FIG. 3 is a side view of the Membrane Covered Structural Panel illustrating the method of attachment to the abutting structure. “G” is the facing material of the structural panel. “H” is the foam core of the structural panel. “I” is the impervious membrane covering the structural panel. “I” illustrates the dado joint method of attaching the structural panel to the abutting structure.

FIG. 4 is a side view of the Membrane Covered Structural Panel. “K” is the impervious membrane. “L” indicates the adhesive coating bonding the membrane to the structural panel. “M” is the foam core of the structural panel. “N” is the facing material of the structural panel.

### DESCRIPTION OF THE PREFERRED EMBODIMENTS

The inventions is a combination of known materials in a unique way to create a new material for the construction of exterior decks such as those appended to residential and commercial structures.

The first known material in the combination is a cored structural panel faced with a durable exterior skin such as plywood or composite board. The core between the exterior skin is comprised of foam or a foam-like substance.

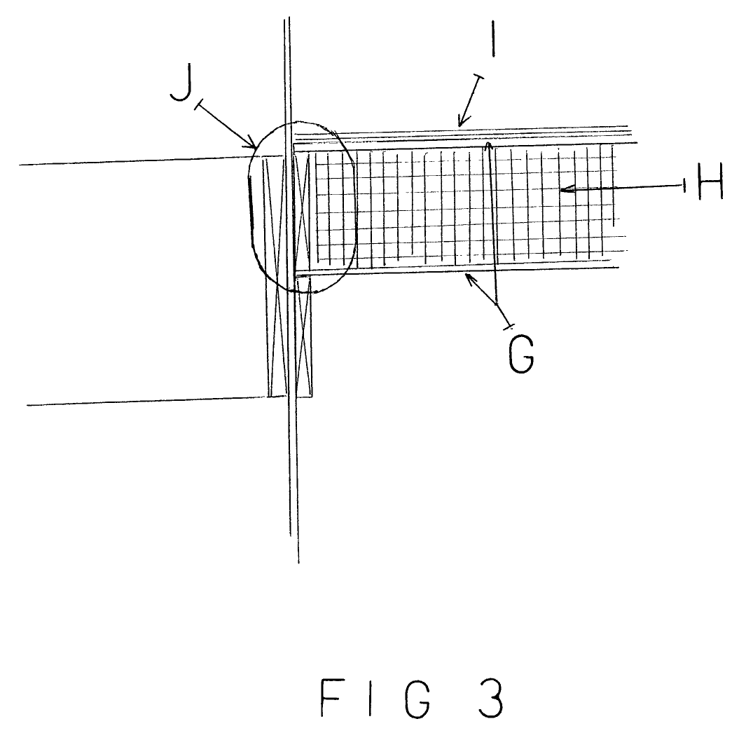

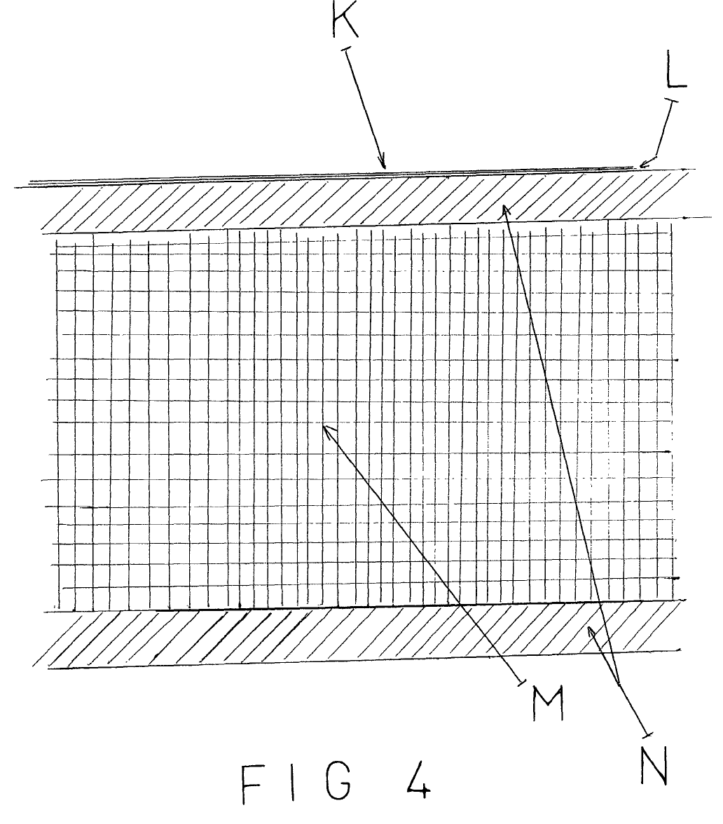

FIG. 4 provides a useful illustration for understanding the interrelation of the core material and the skin material. FIG. 4, item “M” represents the core material. FIG. 4, item “N” represents the durable skin material. The dimension of the core material and therefore the space between the durable skin material is such that commonly available dimension lumber can fit securely between the skins. As is well known in the art, common dimension lumber is sold as 2×4 to 2×12 but the actual dimension of such lumber is somewhat less than the dimension implied by the name 2×4 or 2×6 for example. Assuming that for a 2×6, 2 is the width and 6 is the height, the dimension of the core is such that the width of the 2×6 would fit snugly between the skin of the panel as illustrated in part “J” of FIG. 3.

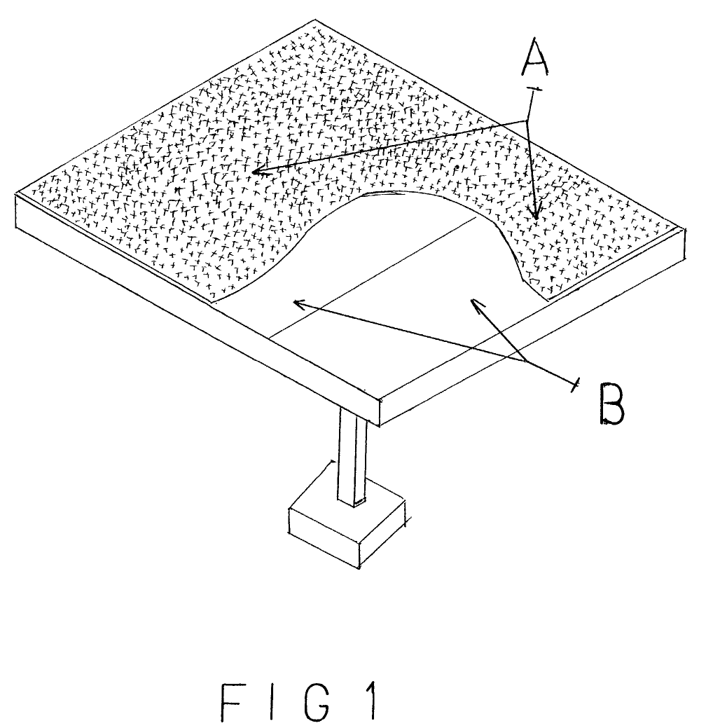

The cored structural panel described above is combined, in the present invention, with an impervious membrane. As illustrated in FIG. 1, the membrane “A” shown in cut away view is positioned such that it forms a continuous cover for the entire deck illustrated in FIG. 1 item “B”.

The membrane is also illustrated in FIG. 4 “K” showing its position on top of the upper exterior skin. It is also a feature of the invention that the membrane is bonded to the upper durable skin of the panel by a suitable chemical or physical adhesive that would be between the membrane and the skin as illustrate by FIG. 4 “L”. It is a feature of the invention that the adhesive material would be applied either to the top of the structural panel, the underside of the membrane or both to form a permanently bonded composite structure, the impervious membrane over the cored structural panel.

An additional aspect of the invention is the method of using the composite membrane covered structural panel to construct decks. The application of the membrane to the structural panels occurs after the construction of the deck so as to minimize the number of seems necessary to create a continual cover of the entire deck as constructed.

The method of constructing decks by the method of this invention begins with suitable dimension lumber and the cored structural panels. The core of structural panels commonly available does not extend completely to the edge of the skin. It is a feature of the invention that the core of the structural panel has its terminus before the edge of the skin such that the channel thus formed has the same dimension as the width of the dimension lumber used in construction of the deck. For example, if the dimension lumber is 1 _{17/32}″×5 _{17/32}″, the top and the bottom skin of the structural panel would extend beyond the perimeter edge of the core by 1 17/32″ on all edges.

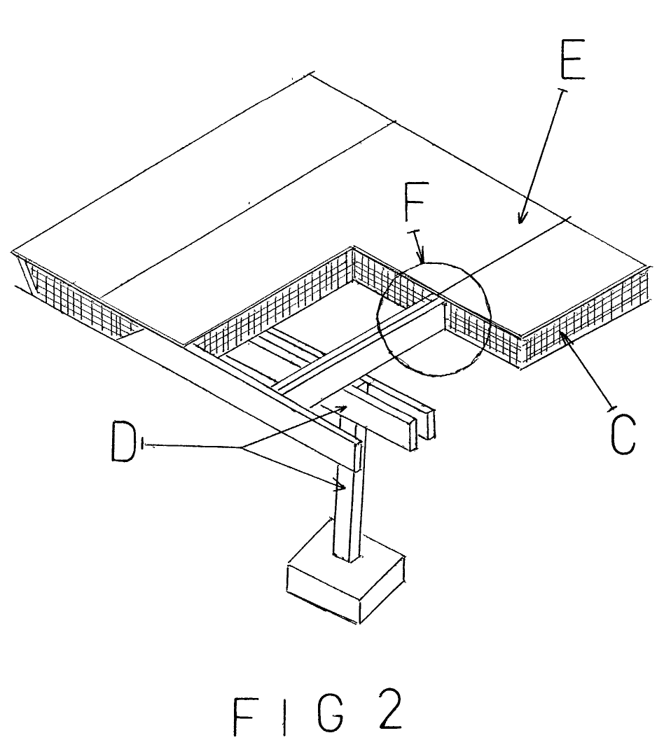

Referring to FIG. 2, it is a feature of the method of construction that a post or posts, FIG. 2 “D”, are placed some suitable distance from the structure to which the deck is attached and a beam is positioned and fastened between and along the top edge of the posts. The beam is positioned parallel to the edge of the structure to which the deck is attached.

It is an additional feature of the invention that the structural panel, without the membrane, is fastened to the structure as is illustrated in FIG. 3 “J”. As is shown in that detail a length of dimension lumber is fastened to the structure at substantially the same level as the beam forming a sill. The structural panel is placed on the beam and engaged with the sill such that the top skin of the panel is above the sill and the bottom skin is below the sill. Suitable fasteners are then driven through the upper and lower skin of the panel into the sill.

Should it be desired to construct a deck larger than a single panel, additional panels can then be positioned and fastened until the desired width of deck is constructed. An additional feature of the invention is the method of joining panels on edge to each other. The method involves a variation of the method by which the panel is attached to the structure. After the first panel is attached to the structure, should it be desired to join additional panels, a length of dimension lumber is placed along the edge and within the channel formed by the top skin of the panel, the edge of the core material and the bottom skin of the panel to which the next panel is to be joined. Since the channel around the edge of the panel is dimensioned to accept the selected dimension lumber, the edge of the panel with the joist installed will be flush with the joist. An additional joist is then fastened to the in place joist forming a double width joist with the individual joists joined sister fashion. Two joists positioned and joined will create tongue, similar to the sill, onto which the adjacent panel is positioned. Suitable fasteners are then driven through the top and bottom skin into the joists. FIG. 2 “F” illustrates, by cut away the relative position of the panels and the joists.

An additional step in the method of construction occurs after a deck of the desired size is assembled by the method described herein. Once the panels are assembled, an impervious membrane is laid over the entire planar surface of the deck. FIG. 1 shows a cut away view of the membrane “A” laid over the deck “B”.

Before application of the impervious membrane, the surface of the deck is coated with a waterproof adhesive. The membrane is then applied to the deck over the adhesive to create a continual chemical or physical bond between the membrane and the upper planar surface of the panel. Another method of attaching the membrane includes applying the adhesive to the underside of the membrane or to both the underside of the membrane and the upper skin of the panel.

Should it be desired to construct a deck larger than the available dimension of membrane it is an additional feature of this method of construction that an adjoining membrane be laid in the same method as described herein. The adjoining membrane is positioned such that it overlaps the abutting membrane. A suitable adhesive is applied to the upper side of one membrane or the under side of the other membrane or to both upper and lower sides such that the membranes are adhesively joined together to form an impervious joint between pieces of the membrane. Multiple pieces of membrane can thus be used to completely cover the deck panels.

I claim:

1. A combination of a structural panel comprised of an upper skin, a core material, a lower skin, and an impervious membrane bonded to the upper skin

2. The structural panel of claim 1 wherein the said upper skin and said lower skin is comprised of plywood or particleboard.

3. The structural panel of claim 1 wherein the said core material is comprised of rigid foam.

4. The structural panel of claim 1 wherein the said upper skin and said lower skin extend beyond the said core material by a distance sufficient to form a channel bounded by the underside of the said upper skin, the edge of the said core material, and the top side of the said lower skin.

5. The structural panel of claim 1 wherein the said channel is so dimensioned to accept dimension lumber such that the upper edge of said dimension lumber and the lower edge of said dimension lumber abuts the underside of the said upper skin, and the top side of the said lower skin.

6. The structural panel of claim 1 further comprising an impervious membrane adhesively bonded to the upper planar surface of the said upper skin.

7. A method of constructing exterior decks using said structural panel or multiple structural panels joined by joists of dimension lumber positioned in said channels and joined together.
The method of construction of claim 7 further comprising a method of covering the said exterior deck with an impervious membrane.

9. The method of construction of claim 7 further comprising a method of attaching the said impervious membrane by applying an adhesive between the upper planar surface of said structural panel and the underside of said impervious membrane to the adhesive covered upper planar surface.

10. The method of construction of claim 7 further comprising a method of attaching additional impervious membranes by overlapping the edges of abutting pieces of said impervious membrane after application of an adhesive between the said overlapping edges.
